(19) United States
(12) Patent Application Publication
(10) Pub. No.: US 2013/0025311 A1
(43) Pub. Date: Jan. 31, 2013

(54) MOTOR VEHICLE REFRIGERANT CIRCUIT WITH A REFRIGERATION SYSTEM CIRCUIT AND A HEAT PUMP CIRCUIT

(71) Applicants: Marc Graaf, Krefeld (DE); Tobias Haas, Koln (DE)

(72) Inventors: Marc Graaf, Krefeld (DE); Tobias Haas, Koln (DE)

(73) Assignee: VISTEON GLOBAL TECHNOLOGIES, INC., Van Buren Twp., MI (US)

(21) Appl. No.: 13/551,740

(22) Filed: Jul. 18, 2012

(30) Foreign Application Priority Data
Jul. 28, 2011 (DE) 10 2011 052 257.3
Jan. 23, 2012 (DE) 10 2012 100 525.7

(51) Int. Cl. B60H 1/03; B60H 1/32

(52) U.S. Cl. 62/238.7; 62/239

(57) ABSTRACT

A fluid conditioning system includes a refrigeration circuit and a heat pump circuit. The refrigeration circuit includes a heat exchanger and an evaporator. The heat pump circuit includes a condenser, a chiller serially connected to the evaporator, and a first expansion member in fluid communication with the chiller, wherein the heat pump circuit is configured to utilize heat from ambient air and a cooling agent circuit for heating a passenger compartment of a vehicle.

### CROSS-REFERENCE TO RELATED APPLICATION

This application claims the benefit of German Provisional Patent Application No. DE 10 2011 052 257.3 filed Jul. 28, 2011, and German Utility Patent Application No. DE 10 2012 100 525.7 filed Jan. 23, 2012, the entire disclosures of which are hereby incorporated herein by reference.

### FIELD OF THE INVENTION

The invention relates to a motor vehicle, and more particularly a motor vehicle refrigerant circuit with a refrigeration system circuit and a heat pump circuit for an air conditioning and heating of the motor vehicle.

### BACKGROUND OF THE INVENTION

Presently, motor vehicles require supplementary heat sources for conditioning a vehicle compartment at relatively low ambient temperatures because a quantity of heat from a drive engine in the motor vehicles is no longer sufficient.

Various approaches to conditioning the vehicle compartment at relatively low ambient temperatures are known in the prior art. Such approaches involve systems for supplying heat and also heat pump circuits for refrigeration systems for air conditioning of vehicles, which are usually present in the vehicles.

For example, a vehicle air-conditioning system is known from DE 102 00 900 A1that enables an interconnection of a heat pump. A cooling circuit of an engine is coupled via a supplementary heat exchanger to a heat pump circuit of a refrigeration system in order to make heat from the cooling circuit of the engine available for heating a vehicle compartment by means of the heat pump. Thus, the heat from the cooling circuit is fed into the heat pump circuit via a supplementary heat exchanger that is integrated into the cooling circuit of the engine.

Further, an air-conditioning system for a vehicle is known from EP 1 623 857 B1, which can be selectively operated in the air-conditioning mode and in a heat pump mode. In the heat pump mode, a heat exchanger is integrated as a heat pump evaporator into a cooling water circuit. As a result, heat from an engine is taken up in the heat pump mode and can be used for heating a vehicle compartment.

An air-conditioning system for vehicles is known from DE 10 2006 026 359 B4, which can also be selectively operated in a refrigeration system mode and in a heat pump mode. Heat is drawn from ambient air by utilizing a refrigeration system condenser as a heat pump evaporator. At low temperatures, an elevated risk of icing in the heat pump evaporator/refrigeration system condenser occurs as a result of unduly high pressure losses in an operation of the heat pump. It is further disadvantageous that an output of the heat pump decreases as the ambient temperature drops, whereas a thermal requirement for appropriate heating of a vehicle compartment increases at low temperatures. Often times, the required heating output cannot be achieved at ambient temperatures of less than −10° C. with the pure air heat pump.

Contrarily, the invention increases the heating output of an air heat pump and a maximum utilization of an available output from the ambient air, as well as optimizes a total performance number of the heat pump.

In certain embodiments, the invention includes a motor vehicle refrigerant circuit with a refrigeration system circuit and a heat pump circuit, wherein a heat pump condenser, a refrigeration system and heat pump evaporator and a chiller of a cooling agent circuit are arranged and connected in series as a supplementary heat pump evaporator in the heat pump circuit. An expansion member is associated with the chiller on a refrigerant side, and means for heating a cooling agent are provided in the cooling agent circuit. In a broad sense, the term “chiller” denotes a heat exchanger that is bound on one side into the cooling agent circuit or a heat exchanger circuit (i.e. a glycol circuit or the like) and that is bound on another side into the refrigerant circuit. The chiller transmits heat from the cooling agent circuit or the heat exchanger circuit to the refrigerant circuit, wherein in a heat pump mode, the refrigerant circuit is switched for heating a vehicle compartment.

It is the objective of this invention to produce a refrigerant circuit including a refrigeration system circuit and a heat pump circuit for an air conditioning and heating of a motor vehicle, wherein an effectiveness and efficiency are maximined, and energy consumption is minimized.

### SUMMARY OF THE INVENTION

In concordance and agreement with the present invention, a battery cooler which minimizes installation space, while being easy to manufacture, economical in material consumption, and structurally robust, has been surprisingly invented.

In one embodiment, a fluid conditioning system, comprises: a refrigeration circuit including a heat exchanger and an evaporator; and a heat pump circuit including a condenser, a chiller serially connected to the evaporator, and a first expansion member in fluid communication with the chiller, wherein the chiller is also in fluid communication with a cooling agent circuit.

In another embodiment, a fluid conditioning system, comprises: a refrigeration circuit including a heat exchanger and an evaporator; and a heat pump circuit including a condenser, a chiller serially connected to the evaporator, and a first expansion member in fluid communication with the chiller, wherein the chiller is also in fluid communication with a cooling agent circuit, the heat pump circuit further including a branch point to divide a flow of a fluid through the heat pump circuit into a first partial mass flow and a second partial mass flow.

In yet another embodiment, a fluid conditioning system, comprises: a refrigeration circuit including a heat exchanger and an evaporator; and a heat pump circuit including a condenser, a chiller serially connected to the evaporator, and an expansion member in fluid communication with the chiller, wherein the heat pump circuit is configured to utilize heat from ambient air and a cooling agent circuit for heating a passenger compartment of a vehicle.

According to an embodiment of the invention, the cooling agent circuit is designed as a heating water circuit of a motor vehicle. Thus, the heating water circuit is provided as a supplementary heat source in the heat pump circuit, which the heating water circuit is provided with means for heating the heating water circuit.

According to another embodiment of the invention, the means for heating the cooling agent circuit and/or the heating water circuit are arranged as an electrical resistance heater such as glow plugs or a positive temperature coefficient (PTC) heating element in the cooling agent circuit, for example.

According to another embodiment of the invention, the expansion member associated with the chiller is arranged upstream of the chiller in a direction of flow of the refrigerant. Alternatively, the expansion member associated with the chiller is arranged downstream of the chiller in the direction of flow of the refrigerant. Advantages of this arrangement are that the refrigerant in the chiller can evaporate at a different temperature level. The temperature level is higher than an ambient temperature level. Thus, the cooling water circuit is also operated at a higher temperature level, minimizing a required pump performance of a cooling water circulation pump.

The refrigerant circuit of the motor vehicle is configured such that during an operation of the heat pump, the chiller is connected in parallel with the heat pump air evaporator. Therefore, both the ambient heat of the air and the heat from the cooling agent circuit can be used to heat the passenger compartment of the vehicle by means of the heat pump. In this embodiment, an evaporation pressure can be slightly raised in comparison with operation without the chiller. Accordingly, a risk of icing on the refrigeration system condenser during the operation of the heat pump is minimized and a suction density along with a mass flow of the refrigerant and a performance of the heat pump is maximized.

According to another embodiment of the invention, the refrigerant circuit includes a branch point for refrigerant arranged downstream of a first expansion valve in the direction of flow of the refrigerant during operation of the refrigeration system.

In the prior art, a second evaporator is operated as a battery cooler in parallel with a passenger compartment evaporator. A branch point is typically arranged upstream of the expansion valve of the passenger compartment evaporator. Thus, the passenger compartment evaporator and the battery cooler are each associated with its own expansion valve. During an operation of the heat pump of prior art, a reversal of flow occurs in the evaporator while the refrigeration system condenser is operated as a heat pump evaporator at a lower temperature level/pressure level than the passenger compartment evaporator. An arrangement of the expansion valves of the prior art would cause the chiller to be unadvantageously operated at an even lower temperature level/pressure level. However, an objective of an arrangement in accordance with the invention with a separate expansion valve upstream of the chiller is to operate the chiller at a similar or slightly higher temperature level/pressure level than that of the refrigeration system condenser.

According to another embodiment of the invention, two expansion valves are advantageously arranged so that they can be flowed through in series during operation of the heat pump. Typically, this is the case during operation of the heat pump, there is a flow through the expansion valve between the heat pump condenser and the passenger compartment evaporator and subsequently either the expansion valve associated with the chiller or the one associated with the heat pump evaporator, or both can be flowed through in parallel.

During operation of the refrigeration system, no appreciable throttling effect occurs in the expansion valve associated with the chiller after the flowthrough of the expansion valve downstream of the inner heat exchanger since a partial mass flow through the passenger compartment evaporator and a partial mass flow through the chiller are brought together at a collection point upstream of a collector. The expansion valve associated with the chiller substantially regulates the ratio of the mass flows through the chiller and through the passenger compartment evaporator.

An advantageous further development of the invention consists in that the refrigerant collector is designed to bring the partial mass flows together.

The design of the invention includes a heat pump circuit that utilizes the heat of the ambient air and a second source for utilizing additional heat integrated into the heat pump circuit. According to an embodiment of the invention, this second source is a cooling agent circuit designed as a cooling water circuit of the vehicle. In particular, in electrical vehicles, a cooling circuit of the driving engine of the electronic performance components of the battery or that is used for cooling several of these components at the same time is integrated into the heat pump circuit via the chiller. An electrical resistance heater, electrical glow plugs, or a PTC heating element can also be integrated into the cooling water circuit.

Thus, in addition to the heat of the electrical driving components, the electrical power is introduced into the cooling water circuit, as a low-temperature circuit in electrical drive systems. The heat is brought by means of the heat pump to a higher temperature level and is utilized for heating the passenger compartment of the vehicle.

If no cooling water circuit is present in the vehicle, a solely heating water circuit is constructed, which receives the means for heating the cooling agent or the heating agent.

An advantage of the invention is the average heating output of the heat pump can be increased by the additional integration of a heat source, which results in reduced electrical power consumption for the heating of electric vehicles in comparison with heating by means of purely electrical direct heating. As a consequence, a range of the vehicle is increased with the same battery capacity.

When used for electrical vehicles, the increase in the range of the vehicle by a decreased input of electrical energy for heating and a better utilization of battery capacity is especially advantageous.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a schematic flow diagram of a refrigerant circuit for a motor vehicle according to an embodiment of the invention, wherein the refrigerant circuit includes a chiller and an expansion valve disposed upstream of the chiller;

FIG. 2 is a schematic flow diagram of a refrigerant circuit for a motor vehicle according to another embodiment of the invention, wherein the refrigerant circuit includes a chiller and an expansion valve disposed downstream of the chiller; and

FIG. 3 is a schematic flow diagram of a refrigerant circuit for a motor vehicle according to another embodiment of the invention, wherein the refrigerant circuit includes three-way valves.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner.

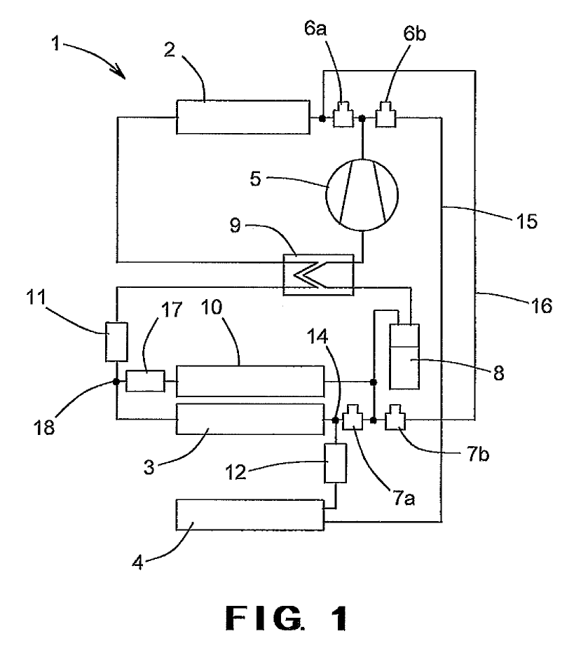

FIG. 1 shows a refrigerant circuit or fluid conditioning system 1 for a motor vehicle according to an embodiment of the invention. The refrigerant circuit 1 is capable of operating in a refrigeration system mode and a heat pump mode.

In the refrigeration system mode, a refrigeration circuit includes a heat exchanger or refrigeration system condenser-heat pump evaporator 2 arranged downstream of a refrigerant compressor 5. In certain embodiments, a refrigerant flows to the heat exchanger 2 through an inner heat exchanger 9 to an expansion valve 11. The inner heat exchanger 9 is also designated as a subcooling counterflow device. The refrigerant is expanded in the expansion valve 11. The expansion valve 11 is configured in such a manner that the expansion valve 11 can be flowed through bidirectionally by the refrigerant. Subsequently, the refrigerant passes via a branch point 18 into a refrigeration system-heat pump evaporator 3.

In a non-limiting example, components are designated as expansion valves that can act as an expansion member. Thus, in addition to expansion valves, the term also covers capillaries or other blocking members that can assume a function of expansion members.

The refrigeration system-heat pump evaporator 3 is operated in both the refrigeration system mode and the heat pump mode as an evaporator for cooling and dehumidifying the air. However, the refrigeration system-heat pump evaporator 3 can also be operated as a quasi-extended heat pump condenser.

Downstream of the refrigeration system-heat pump evaporator 3, a mass flow of the refrigerant passes via a nodal point 14 and an open valve 7a to a refrigerant collector 8. From the refrigerant and collector 8, the mass flow of the refrigerant subsequently flows through the inner heat exchanger 9 to a refrigerant compressor 5 where the refrigeration circuit is closed.

In the heat pump mode, a heat pump circuit includes the refrigerant compressor 5. A valve 6b is connected downstream of the refrigerant compressor 5 such that the refrigerant passes the high-pressure strand 15 of the heat pump to the heat pump condenser 4. On an air side, the heat pump condenser 4 is integrated into the fluid conditioning system for heating air for a vehicle compartment. The refrigerant exiting the heat pump condenser 4 is expanded in the expansion valve 12, and is conducted via the nodal point 14 when the valve 7a is closed to the refrigeration system-heat pump evaporator 3. Within the refrigeration system-heat pump evaporator 3, the air for the air conditioning of the vehicle compartment is cooled and dehumidified, provided that the air entering the refrigeration system-heat pump evaporator 3 is warmer than the refrigerant. If the air is cooler than the cooling agent, the air is heated in the refrigeration system-heat pump evaporator 3 and is not dehumidified. A temperature level in the refrigeration system-heat pump evaporator 3 can be regulated in such a way that the air is heated or cooled and dehumidified. The refrigerant subsequently passes via the branch point 18 to the expansion valve 17 and then into a chiller 10. The chiller 10 is configured in such a manner that in the heat pump mode, the chiller 10 operates as a heat pump evaporator for the cooling water circuit. Downstream of the chiller 10, the refrigerant passes through the refrigerant collector 8 and flows via the inner heat exchanger 9 to the refrigerant compressor 5, after which the heat pump circuit is closed.

The expansion valves 12 and 17 do not have to be configured to permit bidirectionally flow. Only the expansion valve 11 must be configured so that the expansion valve 11 can be flowed through bidirectionally for the operation of the air heat pump.

According to an other embodiment of the refrigerant circuit 1, in the heat pump mode, the mass flow of refrigerant is divided at the branch point 18 downstream of the refrigeration system-heat pump evaporator 3 into two partial mass flows, wherein one partial mass flow is conducted, as described above, via the chiller 10, and parallel thereto, another partial mass flow passes to the heat exchanger 2 via the expansion valve 11, which can be flowed through bidirectionally, and the inner heat exchanger 9.

Thus, in the heat pump circuit, the heat pump is supplied with heat in parallel via the heat exchanger 2 and the chiller 10, both of which function as evaporators. When valve 6a is closed, the partial mass flow of the refrigerant from the heat exchanger 2 passes via the open valve 7b into the heat pump low-pressure strand 16 and flows to the refrigerant collector 8. Within the refrigerant collector 8, the two partial mass flows are combined. The refrigerant is then conducted via the inner heat exchanger 9 to the refrigerant compressor 5.

Alternatively to the set-up of the heat pump circuit with parallel flowthrough in the heat pump mode of chiller 10 and the heat exchanger 2, the strand to the heat exchanger 2 can also be operated individually with the total mass flow of refrigerant, for example, if no heat from the cooling circuit is available or if a capacity of the heat exchanger 2 is sufficient for producing a required heating output of the heat pump.

In very cold ambient temperatures of −10° C. or less and a distinctly warmer water temperature in the cooling circuit or heating circuit, it can be advantageous not to operate the heat exchanger 2 and to take the entire required output from the cooling water circuit. As a result, a suction pressure is raised and the mass flow of the refrigerant is elevated. In this manner, a performance of the heat pump is increased.

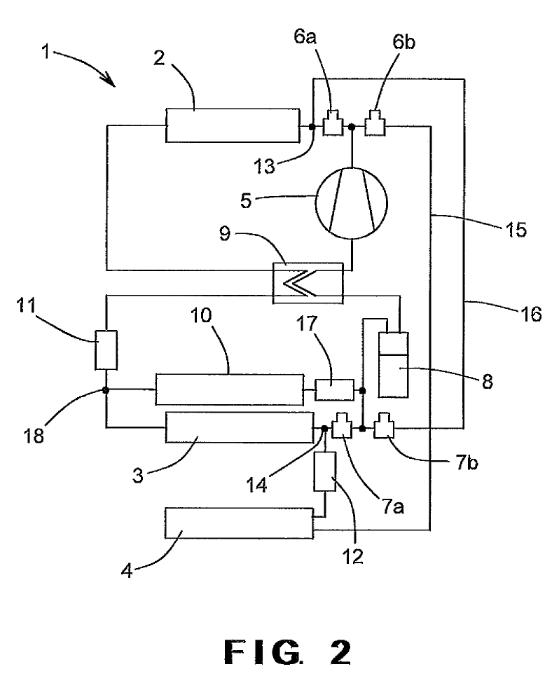

FIG. 2 shows a refrigerant circuit or fluid conditioning system 1 of a motor vehicle according to another embodiment of the invention. The refrigerant circuit 1 includes a chiller 10 with expansion valve 17 disposed downstream of the chiller 10 in a direction of flow of the refrigerant.

The difference between the refrigerant circuit shown in FIG. 1 and the refrigerant circuit 1 shown in FIG. 2 is that in the heat pump circuit, the expansion valve 17 for a mass flow of the refrigerant is arranged downstream of the chiller 10.

The arrangement shown in FIG. 2 is advantageous if a minimum temperature of the cooling water is limited, especially if a limit value is above the ambient temperature. Moreover, the arrangement shown in FIG. 2 permits an effective utilization of an area surrounding the heat source, since a mass flow can be minimized by the heat exchanger 2. Therefore, an output can be taken up from the surrounding area with a minimal pressure loss and a minimal temperature difference between the refrigerant and the ambient air. In addition, a maximum mass flow also with a minimal temperature difference between the refrigerant and the cooling water can be conducted via the chiller 10. As a consequence, the cooling water is not cooled unnecessarily, a risk of icing on the heat pump air evaporator is minimized, and an obtainable heating output of the heat pump is maximized.

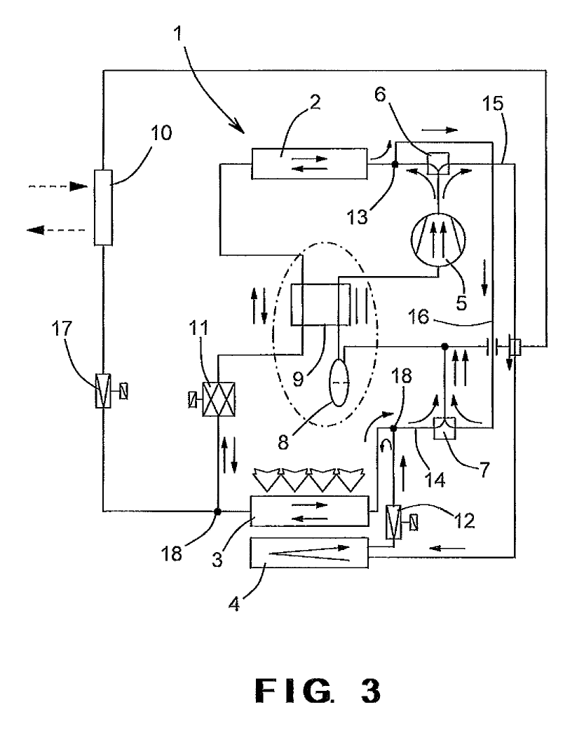

FIG. 3 shows a refrigerant circuit of fluid conditioning system 1 of a motor vehicle according to another embodiment of the invention. The heat pump circuit includes an expansion valve 17 arranged, as in FIG. 1, upstream of the chiller 10 in a direction of flow of the refrigerant. The difference between the refrigerant circuit 1 shown in FIG. 1 and the refrigerant circuit 1 show in FIG. 2 is valves 6a and 6b at an outlet of a refrigerant compressor 5 and valves 7a and 7b upstream of a refrigerant collector 8 shown in FIG. 1 are formed in FIG. 3 as 3-way valves 6 and 7, respectively.

From the foregoing description, one ordinarily skilled in the art can easily ascertain the essential characteristics of this invention and, without departing from the spirit and scope thereof, can make various changes and modifications to the invention to adapt it to various usages and conditions.

### LIST OF REFERENCE NUMERALS

1 refrigerant circuit

2 refrigeration system condenser, heat pump air evaporator

3 refrigeration system—heat pump evaporator, passenger compartment evaporator

4 heat pump condenser

5 refrigerant compressor

6a,b valve

7a,b valve

8 refrigerant collector

9 inner heat exchanger, subcooling counterflow device

10 chiller, heat pump evaporator, cooling water circuit

11 bidirectional expansion valve

12 expansion valve

13 nodal point

14 nodal point

15 heat pump high-pressure strand

16 heat pump low-pressure strand

17 expansion valve

18 branch point

What is claimed is:

1. A fluid conditioning system, comprising:
a refrigeration circuit including a heat exchanger and an evaporator; and
a heat pump circuit including a condenser, a chiller serially connected to the evaporator, and a first expansion member in fluid communication with the chiller, wherein the chiller is also in fluid communication with a cooling agent circuit.

2. The fluid conditioning system according to claim 1, wherein the cooling agent circuit includes a means for heating a cooling agent.

3. The fluid conditioning system according to claim 2, wherein the means for heating the cooling agent includes at least one of an engine of a motor vehicle, at least one electronic component, a battery, an electrical resistance heater, at least one glow plug, and at least one positive temperature coefficient heating element.

4. The fluid conditioning system according to claim 1, wherein the cooling agent circuit is configured as one of a heating water circuit and a cooling water circuit of a motor vehicle.

5. The fluid conditioning system according to claim 1, wherein the first expansion member is disposed upstream of the chiller in respect of a direction of flow of a fluid through the heat pump circuit.

6. The fluid conditioning system according to claim 1, wherein the first expansion member is disposed downstream of the chiller in respect of a direction of flow of a fluid through the heat pump circuit.

7. The fluid conditioning system according to claim 1, wherein the chiller is connected in parallel to the heat exchanger in the heat pump circuit.

8. The fluid conditioning system according to claim 1, wherein at least one of the refrigeration circuit and the heat pump circuit includes a fluid collector.

9. The fluid conditioning system according to claim 1, wherein the heat pump circuit further includes a branch point to divide a flow of a fluid through the heat pump circuit into a first partial mass flow and a second partial mass flow.

10. The fluid conditioning system according to claim 1, wherein at least one of the refrigeration circuit and the heat pump circuit includes at least one valve to direct a flow of fluid therethrough.

11. The fluid conditioning system according to claim 1, wherein the heat pump circuit further includes a second expansion member in fluid communication with the evaporator and the condenser.

12. The fluid conditioning system according to claim 11, wherein the first expansion member is in fluid communication with the second expansion member.

13. The fluid conditioning system according to claim 10, wherein the heat pump circuit includes a third expansion member.

14. The fluid conditioning system according to claim 13, wherein the third expansion member is configured to permit bidirectional flow therethrough.

15. The fluid conditioning system according to claim 1, wherein the heat exchanger operates as a condenser in the refrigeration circuit and as an evaporator in the heat pump circuit.

16. A fluid conditioning system, comprising:
a refrigeration circuit including a heat exchanger and an evaporator; and
a heat pump circuit including a condenser, a chiller serially connected to the evaporator, and a first expansion member in fluid communication with the chiller, wherein the chiller is also in fluid communication with a cooling agent circuit, the heat pump circuit further including a branch point to divide a flow of a fluid through the heat pump circuit into a first partial mass flow and a second partial mass flow.

17. The fluid conditioning system according to claim 16, wherein the second partial mass flow is directed through at least a portion of the refrigeration circuit.

18. The fluid conditioning system according to claim 16, wherein at least one of the refrigeration circuit and the heat pump circuit further includes at least one valve to direct a flow of a fluid therethrough.

19. The fluid conditioning system according to claim 18, wherein the at least one valve is configured as a three-way valve.

20. A fluid conditioning system, comprising:
a refrigeration circuit including a heat exchanger and an evaporator; and
a heat pump circuit including a condenser, a chiller serially connected to the evaporator, and an expansion member in fluid communication with the chiller, wherein the heat pump circuit is configured to utilize heat from ambient air and a cooling agent circuit for heating a passenger compartment of a vehicle.
